(19) United States
(12) Patent Application Publication
(10) Pub. No.: US 2006/0238071 A1
(43) Pub. Date: Oct. 26, 2006

(54) Motor production line and method of controlling the same

(76) Inventors: Yoshiyuki Kawasaki, Aichi-ken (JP); Tooru Kuroyanagi, Aichi-ken (JP); Takeshi Yokoyama, Aichi-ken (JP)

Correspondence Address: Bacon & Thomas, 625 Slaters Lane, Fourth Floor, Alexandria, VA, 22314-1176, US

(21) Appl. No.: 10/525,721

(22) PCT Filed: Mar. 31, 2004
(86) PCT No.: PCT/JP04/04733

§ 371 Date: Jan. 12, 2006

(30) Foreign Application Priority Data
Apr. 18, 2003 (JP) 2003-114548

(51) Int. Cl. H02K 15/00; B23P 19/00

(52) U.S. Cl. 310/321; 29/596; 29/732; 29/733; 29/564.5

(57) ABSTRACT

A motor production line for producing a stator includes a press station for forming a stator core by feed therethrough of a long steel plate to punch therefrom a plurality of plates assembled into a stator core, and a stator assembling station for assembling a stator including the stator core. A stator core conveyer is arranged between the stator station and the press station to successively and directly convey the stator cores formed at the press station to the stator assembling station. Preferably, the production line further includes a rotor assembling station, and a rotor core conveyer for successively and directly conveying rotor cores formed at the press station to the rotor assembling station.

### CROSS-REFERENCE TO RELATED APPLICATIONS

This application is a National Phase Application (35 USC 371) of PCT/JP2004/004733 and claims priority of Japanese Application No. 2003-114548 filed Apr. 18, 2003.

### TECHNICAL FIELD

The present invention relates to a production line for the production of many types of motors in small quantities and to a control method for controlling the production line.

### BACKGROUND ART

In the production of a motor, the rotor and the stator of the motor are separately fabricated and are combined together in the final assembly of the motor. Further, the cores of both the rotor and the stator are laminates of electromagnetic steel plates that have been punched into a desired shape. These rotor and stator cores are formed by using a press into which an elongated electromagnetic steel plate is fed and passed through a plurality of pressing steps.

FIG. 9 shows a conventional line 9 for mass production of motors as including a dedicated press plant 91 with a large press apparatus which efficiently produces the rotor and stator cores. The press apparatus of the press plant 91 is capable of punching at a rate of 100 SPM or higher.

A stock warehouse 92 is located near the press plant 91 for storing rotor cores and stator cores produced in the press plant 91, as are a plurality of assembly plants 93, 94, 95, - - - where the rotor cores and stator cores are assembled.

The press plant 91 produces rotor and stator cores of the same specifications in large quantities, and the rotor and stator cores are conveyed from the press plant 91 to the stock warehouse 92 for storage. Thereafter, the rotor and stator cores of another type are produced in large quantities, and are conveyed from the press plant 91 to the stock warehouse 92 for storage.

The assembly plants 93, 94 and 95 receive the rotor and stator cores from the stock warehouse 92, and are assembled.

A conventional press apparatus, as used in press plant 91, is disclosed in, for example, JP-A-2002-136065.

However, the conventional motor production line suffers from problems as described below.

The production of many types of motors in small quantities, using the above-described conventional motor production line, inevitably results in great quantities of different types of rotor and stator cores that require a large storage space.

Further, because the rotor and stator cores are stored for extended periods of time the quality of insulation, for example, deteriorates due to rust and adhesion of foreign matter.

Further, while being stored for extended periods of time in the stock warehouse, the chances increase for intermingling, deformation, etc. To suppress deterioration of quality, countermeasures must be taken, such as rust-prevention treatment, housing the cores in stock boxes, etc., thus driving up the management cost.

Moreover, if the rotor and stator cores are stored for extended periods of time as described above, prolonging the time from the start of production until use, the chances for damage are increased.

### SUMMARY OF THE INVENTION

Accordingly, the invention solves the above-mentioned problems by providing a motor production line well suited for the production of many types of motors in small quantities, while decreasing storage time, and by providing an improved production method.

In one aspect, the present invention provides a motor production line for producing at least a stator comprising:

a press station, including a punch press and through which an elongated plate is fed, for forming steel plates in a plurality of punch press operations, and for laminating the plural steel plates together to form a stator core;

a stator assembling station for assembling a stator including the stator core in a plurality of production steps; and

a stator core conveyer arranged between the stator assembling station and the press station for successively and directly conveying the stator cores formed at the press station to the stator assembling station.

Thus, the motor production line of the invention includes the press station and the stator assembling station with the stator core conveyer therebetween. In other words, the press station and the stator assembling station are coupled together in an organic manner through the stator core conveyer to thereby form a single continuous production line.

As described above, the stator core conveyer conveys the stator cores formed at the press station to the stator assembling station, successively and directly. Alternatively, the stator cores, however, may be conveyed while arbitrarily changing their order. Unlike the prior art, therefore, the stator cores need not be stored as stock. This precludes any decrease in the quality of the stator cores and, hence, suppresses the percent of defectives, which problems are inherent in the prior art. Moreover, neither a stock warehouse nor preservation is required, and therefore the overall cost of production can be reduced.

Because the stator cores produced at the press station are successively conveyed to the stator assembling station, and are successively assembled into stators, the stators are produced in a minimum lead (production+storage+transfer) time. This ensures a reduction in the total time required to produce a finished motor, as compared to the prior art.

The press station need have only a capability for production of one type of stator. Unlike the prior art, therefore, there is no need for a large, high-speed and expensive press apparatus, and the cost related to the facility can be greatly decreased. Instead, a plurality of similar motor production lines can be utilized to produce motors of different specifications. Therefore, motors of many types can be ideally produced in small quantities.

In a second aspect the present invention provides a method for controlling the motor production line which includes a press station for forming rotor and stator cores by feeding an elongated steel plate through a plurality of punch press operations to cut out a plurality of steel plates, and for laminating the plural steel plates together into a rotor core and into a stator core; a rotor assembling station for assembling a rotor, including the rotor core, in a plurality of production steps, and a stator assembling station for assembling a stator in a plurality of production steps, the method comprising the steps of:

accepting a production instruction inclusive of data related to the number N of motors to be produced;

starting the operations of the press station, the rotor assembling station and the stator assembling station after having accepted the production instruction; and

halting the operations of the press station depending upon the production in the rotor assembling station and the stator assembling station; wherein

if the number of the finished rotors assembled at the rotor assembling station is denoted by R₁, the number of the half assembled rotors by R₂, the number of the finished stators assembled at the stator assembling station by S₁ and the number of the half assembled stators by S₂, then, the press halting step halts the operations at the press station when N≦R₁+R₂ and N≦S₁+S₂.

A variety of methods can be employed for controlling the motor production line, other than that involving a press halting step as in the above second aspect of the invention described above.

In the press halting step, it is judged whether the press apparatus (e.g., punch press) should be halted, depending upon the production of the rotor assembling station and the stator assembling station, i.e., depending upon whether the total number of finished units and half finished units has reached a number N of units that are to be produced. The press station operations continue until the total number reaches N. When the total number reaches N for both the rotors and the stators, the operations of the press station are discontinued.

In the above motor production line, therefore, the production is executed continuously from the formation of the rotor cores and stator cores through assembly of the rotors and stators only when necessary and only to the extent of production of a required quantity. The production time is minimized from the start of production until finishing and, no stock requires storage.

As described above, the control method of the present invention enables the motor production line to operate to excellent advantage.

### BRIEF DESCRIPTION OF THE DRAWINGS

FIG. 1 is a schematic view of a motor production line according to an embodiment of the present invention;

FIG. 2a is a plan view of a rotor core formed by a press in accordance with the embodiment of FIG. 1;

FIG. 2b is a side view of the rotor core of FIG. 2a;

FIG. 3a is a plan view of a stator core formed at the press station according to the embodiment of FIG. 1;

FIG. 3b is a side view of the stator core of FIG. 3a;

FIG. 4a is a plan view of a rotor fabricated at a rotor assembling station according to the embodiment of FIG. 1;

FIG. 4b is a side view of the rotor core of FIG. 1;

FIG. 5a is a plan view of a stator fabricated at the stator assembling station according to the embodiment of FIG. 1;

FIG. 5b is a side view of the stator of FIG. 5a;

FIG. 6 is a flowchart of a method for controlling the motor production line of FIG. 1 in accordance with an embodiment of the method of the present invention;

FIG. 7 is a diagram illustrating lead times in a comparative example;

FIG. 8 is a diagram illustrating lead times in practice of the embodiment of FIG. 6; and

FIG. 9 is a diagram of a conventional layout of a motor production plant.

### DESCRIPTION OF THE PREFERRED EMBODIMENTS

In accordance with objectives of the invention, it is preferred that the press station have the capability of forming both a stator core and a rotor core by lamination of a plurality of steel plates, and that the motor production line includes a rotor assembling station for assembling a rotor in a plurality of production steps, and a rotor core conveyer arranged between the rotor assembling station and the press station for successively and directly conveying the rotor cores formed at the press station to the rotor assembling station.

The press station and the rotor core assembling station are organically coupled together. Likewise, the press station and the stator assembling station are organically coupled together by a conveyor, optionally a stator core conveyor separate from and in addition to the rotor core conveyor.

The rotor cores and the stator cores produced at the press station are successively conveyed in parallel to the rotor assembling station and to the stator assembling station, where they are successively assembled into rotors and stators. Subsequently, the rotors and the stators are combined together to obtain finished products in a minimum lead time (production time plus storage time and transfer time). In this manner, the potential for harm due to a long lead time is largely eliminated.

It is preferred that the motor production line includes a centralized control unit for controlling apparatus at the press station, apparatus at the stator assembling station, apparatus at the rotor assembling station, the stator core conveyer and the rotor core conveyer.

The centralized control unit exclusively manages and controls the apparatus at the press station, apparatus at the stator assembling station, apparatus at the rotor assembling station, with the stator core conveyer and rotor core conveyer maintaining smooth linkages to the different apparatuses in order to effect efficient production.

The rotor core conveyer and the stator core conveyer can be any of various types, such as a roller conveyer, a belt conveyer, a lifter, a loader, a robot, or a combination thereof.

It is further preferred that the rotor core conveyer and the stator core conveyer are integrated into common (single) conveyer apparatus. However, the rotor core conveyer and the stator core conveyer may be separately arranged as dedicated facilities. Every time a rotor core and a stator core are formed at the press station, they may be alternately conveyed to the rotor assembling station and to the stator assembling station. In this manner, the cost of the facility can be decreased, and the area required for the factory can be reduced.

It is further preferred that the rotor delivery line 30 for delivering the rotor assembled at the rotor assembling station and the stator delivery line 40 for delivering the stator assembled at the stator assembling station, meet together at a common delivery station 50, and that every rotor and stator, to be paired together in fabrication of a motor, are alternately delivered simultaneously or consecutively.

The paired rotor and stator are carried from the common delivery station 50, simultaneously or consecutively, by a common conveyor 51 to a motor assembly station or facility (not shown). In the subsequent step of combining the rotor and the stator into one motor, therefore, there is no need for separate conveyance of a rotor or a stator. Therefore, the steps involved in manufacture of motors are better rationalized because the rotor and the stator to be combined together are delivered together in the same (single) lot. Accordingly, dimensional errors are reduced, and motors of higher quality can be produced.

### Embodiment

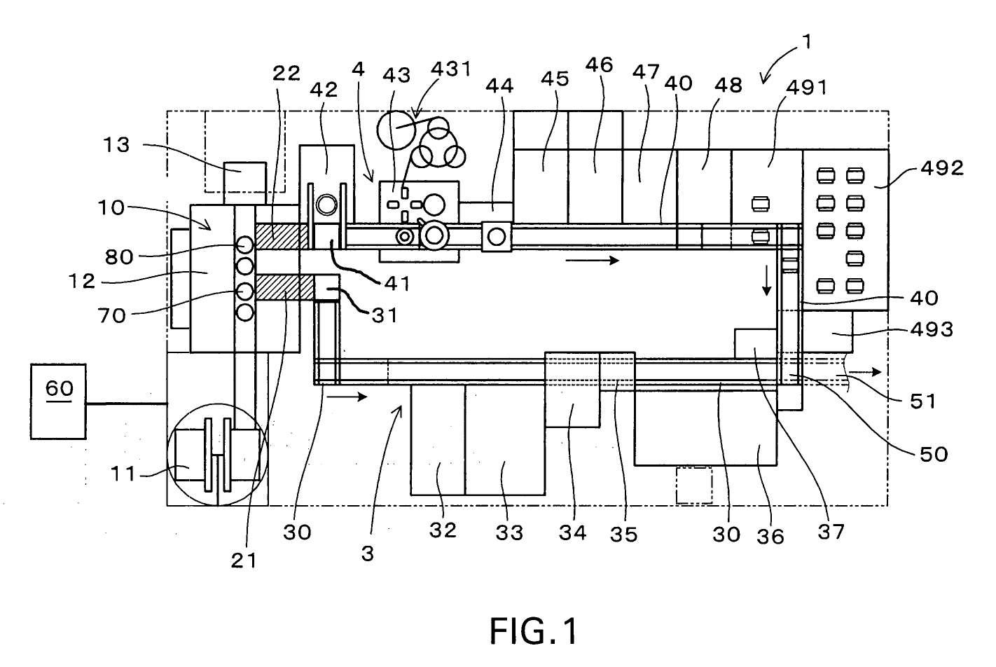

The motor production line according to a preferred embodiment of the invention will now be described with reference to FIGS. 1 to 8.

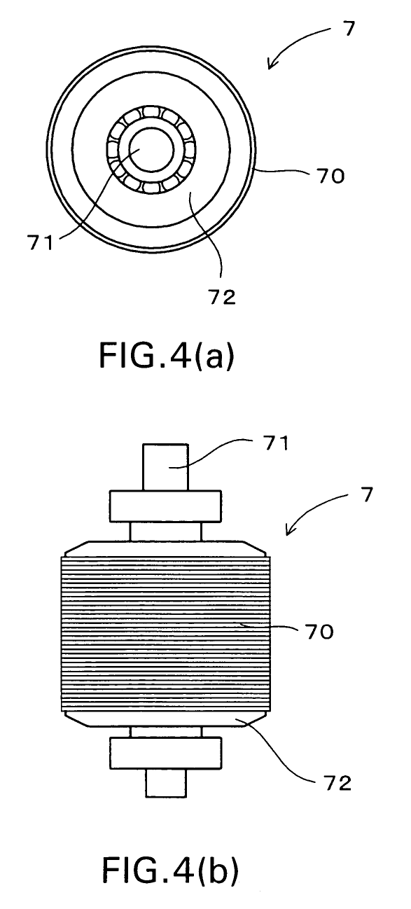

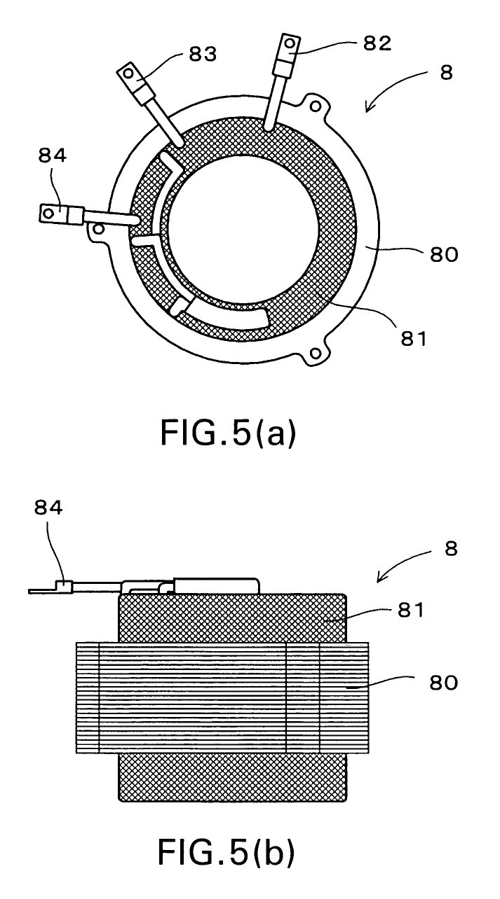

Referring to FIG. 1, a motor production line 1 produces a rotor 7 (FIG. 4) and a stator 8 (FIG. 5) simultaneously and in parallel, for assembly into a motor.

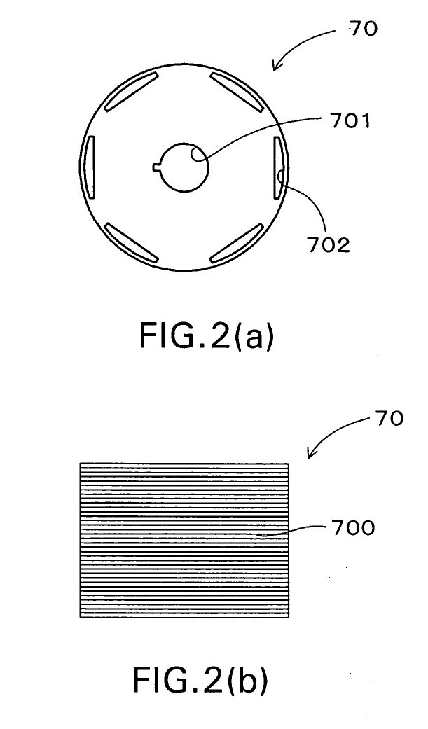

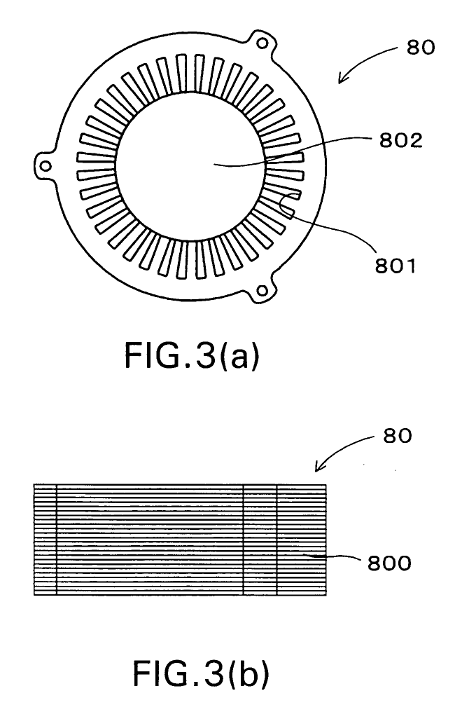

As shown in FIG. 1, the motor production line 1 includes a press station 10 for forming a rotor core 70 (FIG. 2) and a stator core 80 (FIG. 3) by feeding an elongated steel plate through the punch press 12 to cut therefrom a plurality of steel plates, a rotor assembling station 3 for assembling a rotor 7 from the rotor core 70 in a plurality of production steps, and a stator assembling station 4 for assembling a stator 8 from the stator core 80 in a plurality of production steps.

Between the rotor assembling station 3 and the press station 10 is a rotor core conveyer 21 for successively and directly conveying the rotor cores 70 formed at the press station 10 to the rotor assembling station 3. Between the stator assembling station 4 and the press station 10 is a stator core conveyer 22 for successively and directly conveying the stator cores 80 formed at the press station 10 to the stator assembling station 4.

FIGS. 2 to 5 illustrate the rotor core 70 and the stator core 80 formed in the press station 10 of this embodiment, and the rotor 7 (FIGS. 4(a) and 4(b)) and the stator 8 (FIGS. 5(a) and 5(b)) fabricated from same.

Referring to FIG. 2, the rotor core 70 is a laminate of a plurality of punched steel plates 700 which have central shaft holes 701 which receive a rotary shaft 71 (FIG. 4), and which have, near their outer periphery, holes 702 for mounting magnets. The rotor assembling station 3 incorporates the rotor core 70 into the rotor 7 as shown in FIG. 4. The rotor 7 includes a rotary shaft 71 extending through the center of the rotor core 70, magnets, and rotor core-holding plates 72 at both end surfaces of the rotor core 70.

Referring to FIG. 3, the stator core 80 is likewise a laminate of a plurality of punched steel plates 800 which have central through holes 802, and slots 801 opening at their inner peripheral edge surface. The stator assembling station 4 incorporates the stator core 80 into a stator 8 as shown in FIG. 5. The stator 8 has a group of coils 81 inserted in the slots 801 and secured therein by application of a varnish, and has a plurality of coil neutral points 82 to 84 extending therefrom.

FIG. 1 shows a motor production line 1 according to one embodiment of the present invention as including a press station 10 and a blank feeding device 11 for feeding a steel plate blank material from a coil. The plates of the rotor cores 70 and the stator cores 80 are punched from the blank material by forward-feed punch press 12 which has a plurality of punching stages and which is arranged downstream of the blank feeding device. A scrap pallet portion 13 is used for recovering scrap produced by the punch press operation.

The forward-feed press station 10 faces the inlet side of the rotor assembling station 3 and the stator assembling station 4, and is provided with a rotor core conveyer 21 and a stator core conveyer 22.

The rotor core conveyer 21 and the stator core conveyer 22 in this embodiment are both roller conveyers. The rotor core conveyer 21 delivers a rotor core 70 to the inlet side of the rotor assembling station 3 each time a rotor core 70 is formed by the punch press 12. Similarly, the stator core conveyer 22 delivers a stator core 80 to the inlet side of the stator assembling station 4 each time a stator core 80 is formed by the punch press 12.

The rotor core conveyer 21 and the stator core conveyer 22 can be conveyers other than roller conveyers. Further, the rotor core conveyer 21 and the stator core conveyer 22 may be combined into a single common conveyer.

On the inlet (receiving) side of the rotor assembling station 3, there is provided a lift 31 which lifts a rotor core 70 received from the rotor core conveyer 21 to a predetermined height to deliver it to the rotor conveyor line 30.

The conveyer line 30 serves to carry the rotor core 70 through the successive production steps, toward the outlet side of the rotor assembling station 3.

As shown in FIG. 1, the rotor assembling station 3 includes a magnet assembling station 32 for inserting the magnets into the rotor core, an adhesive application station 33 for applying an adhesive to secure the magnets, a shaft station 34 for securing a shaft within the rotor core (with threaded nuts), a resolver station 35 for press-inserting a resolver rotor (for detecting magnetic pole position) into the shaft, and a D/B measurement/correction station 36 for measuring and correcting rotational balance.

On the inlet (receiving) side of the stator assembling station 4, further, there is provided a lift 41 for lifting the stator core 80 received from the stator core conveyer 22 to a predetermined height to deliver it to a conveyor line 40.

The stator conveyor line 40 serves to carry the stator cores 80 through the successive production steps, toward the outlet side of the stator assembling station 4.

As shown in FIG. 1, the stator assembling station 4 includes an insertion station 42 for inserting insulation paper into the slots 801 of a stator core 80, a coil mounting station 43 for mounting a coil (formed in coil-forming station 431) and inter-phase insulation paper on the stator core 80, and a sleeve station 44 for applying insulating sleeves on the lead wires. Downstream of the sleeve station 44 is a neutral point joining station 45 for joining the neutral points of the coil mounted on the stator core 80, a C/E station 46 for trimming coil end portions to a desired shape, a bundling station 47 for bundling together a plurality of coil end portions, a power cable attachment station 48 for joining electrical contacts to the coil, a varnish application station 491 for impregnating the coil with a varnish, a curing station 492 for curing the applied varnish, and a checking station 493 for measuring electric characteristics.

The rotor conveyer line 30 delivers the rotors 7 assembled at the rotor assembling station 3 and the stator conveyer line delivers the stators 8 assembled at the stator assembling station 4, to meet together at a common receiving station 50.

Adjacent the common receiving station 50, is a laser engraving apparatus 37 for marking (printing) the finished rotor 7 and stator 8 by using a laser beam.

Rotors 7 and stators 8, which carry the necessary markings are alternately delivered by a common conveyor 51 to a motor assembly station (not illustrated) where a paired rotor 7 and stator 8 are assembled into a motor.

Further, the motor production line 1 of this embodiment includes a central control unit 60 capable of controlling all of the apparatus at the press station 10, apparatus at the stator assembling station 4, apparatus at the rotor assembling station 3, the stator core conveyer 22 and the rotor core conveyer 21. The control of all of the aforementioned manufacturing operations is accomplished exclusively by the centralized control unit.

As noted above the motor production line 1 of the embodiment of FIG. 1 has a central control unit 60 which receives an instruction from a production management computer (not shown) at a superior position, and which controls the operations of the press station 10, the rotor assembling station 3 and the stator assembling station 4.

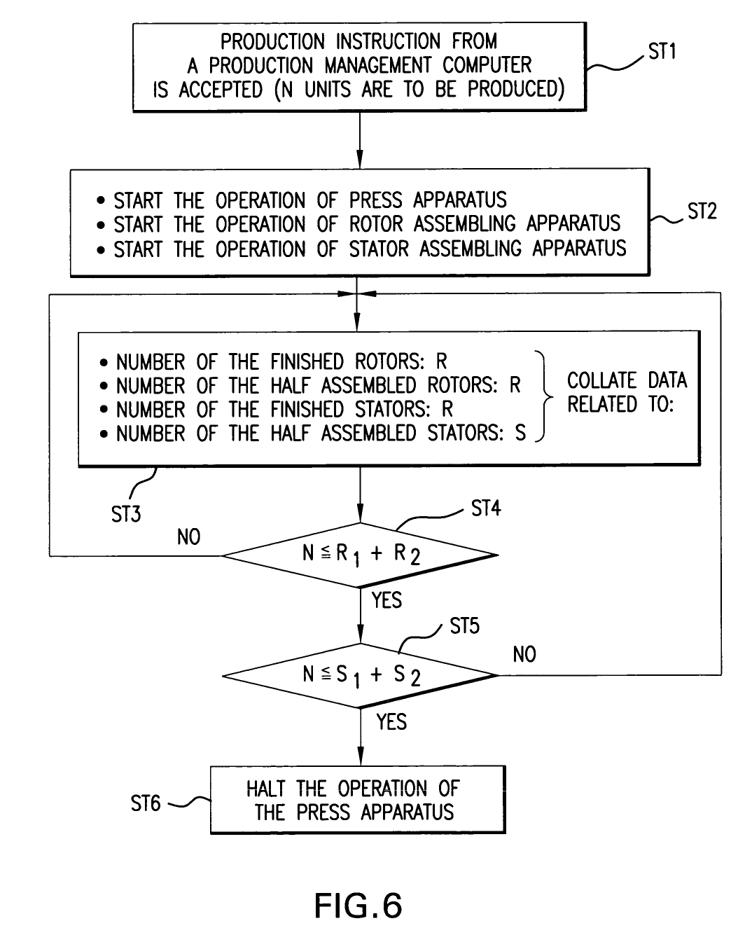

FIG. 6 is a flowchart illustrating control of the motor production line 1.

ST1: A production instruction, inclusive of data related to the number N of motors to be produced, is accepted by the central control unit 60.

ST2: In response to the production instruction, the central control unit 60 starts operations of the press station 10, rotor assembling station 3 and stator assembling station 4. At this time, the rotor core 70 and the stator core 80 have not yet been fed to the rotor assembling station 3 or to the stator assembling station 4. Therefore, the assembling operation has not yet been started. After a while, as rotor cores 70 and stator cores 80 are fed to the rotor assembling station 3 and to the stator assembling station 4, the production steps performed at these stations are started.

Then, in parallel with the formation of a rotor core 70 and a stator core 80 at the press station 10, a rotor 8 is fabricated at the rotor assembling station 3 and a stator 7 is fabricated at the stator assembling station 4 at the same time.

Next, the control apparatus executes preparatory steps (ST3 to ST5) for executing a press-halting step (ST6) to halt the operations at the press station 10.

ST3: The central control unit continues to collect the data related to a number R₁ of the finished rotors representing the accumulated number of the rotors 7 completely assembled at the rotor assembling station 3, a number R₂ of the half assembled rotors representing the number of the rotor cores half assembled at the rotor assembling station 3, as well as a number S₁ of the finished stators representing the accumulated number of the stators 8 completely assembled at the stator assembling station 4 and a number S₂ of the half assembled stators representing the number of the stator cores half assembled at the stator assembling station 4.

ST4: A judgement is made as to whether or not the total number of R₁ and R₂ is greater than N. When R₁+R₂ is greater than N, the routine proceeds to the next step ST5.

ST5: A judgement is made as to whether or not the total number of S₁ and S₂ is greater than N. Only when S₁+S₂ is greater than N, does the routine proceed to next step ST6.

ST6: Operation at the press station 10 is discontinued as described above.

The above control method makes it possible to maximize the excellent advantages of the motor production line 1, and to produce rotors and stators, from the formation of the rotor cores and stator cores through the assembly of the rotors and stators, only as necessary and only in a required quantity. Time from the start of production until the finishing is minimized and, besides, no wasteful storage of stock is required.

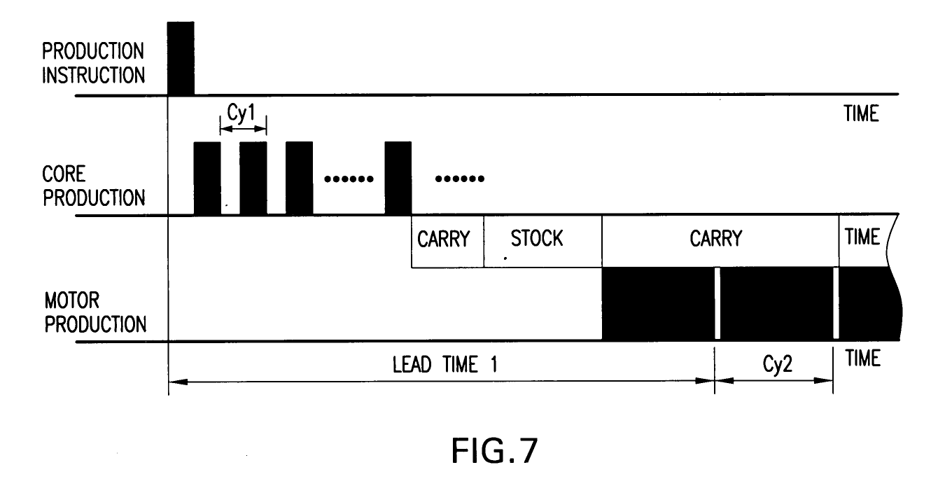

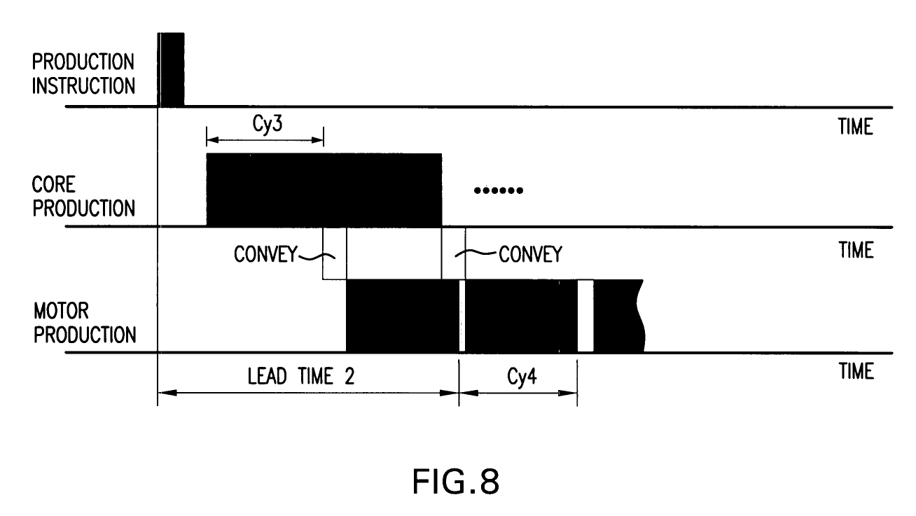

Next, the effect of shortening the lead time will be briefly described with reference to FIGS. 7 and 8.

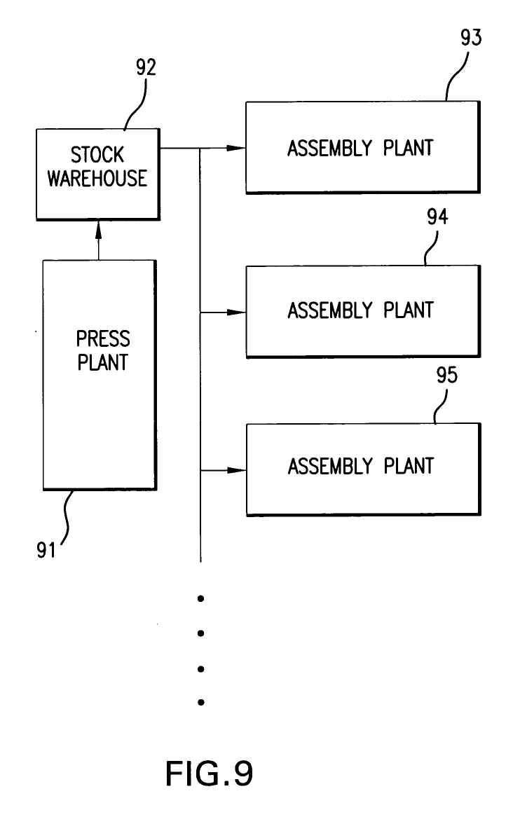

FIG. 7 illustrates a comparative example including a press station 91 (FIG. 9) equipped with a conventional large punch press for mass production, and FIG. 8 illustrates an example of a time line in use of the motor production line 1 of the embodiment of FIG. 1.

In both FIGS. 7 and 8, the abscissas represent time, the uppermost stage represents the timing at which the production instruction is issued, the middle stage represents the core production cycle times (Cy1, Cy3) for forming a rotor core and a stator core of a motor at the press station, and the lowermost stage represents the motor production cycle times (Cy2, Cy4) for assembling the rotor and the stator.

As can be understood from FIGS. 7 and 8, the core production cycle time Cy1 according to the prior art is very much shorter than that for the core production cycle time Cy3 of the embodiment of FIG. 1. In both the prior art and the embodiment of the present invention, however, the motor production cycle times Cy2 and Cy4 are nearly the same length.

In the prior art as illustrated in FIG. 9, the rotor cores and the stator cores are produced in the press station 91 with high efficiency and in large quantities, and are successively conveyed to the stock warehouse 92. The assembly plant 93 receives transported rotor cores and stator cores and starts motor production after having confirmed that rotor cores and stator cores of predetermined quantities have been stored. According to the prior art, therefore, the lead time 1 becomes very long, including time required for production of many rotor cores and stator cores, a stock-storing period and transport time.

In the embodiment of the present invention, on the other hand, time 2 includes only a core production cycle time Cy3, a motor production cycle time Cy4, as well as time for transfer of the rotor core and the stator core to the rotor assembling station 3 and to the stator assembling station 4, using the rotor core conveyer 21 and the stator core conveyer 22. Therefore, assembly time 2 is very much shorter than time 1 of the prior art.

In the motor production line 1 of the embodiment of the invention described above, the press station 10, rotor assembling station 3 and stator assembling station 4 are coupled together through the rotor core conveyer 21 and the stator core conveyer 22 in an organic manner to form a single continuous line as a whole.

Unlike the prior art, therefore, the rotor cores 70 and the stator cores 80 need not be stored at all as stock. This precludes deterioration in the quality of the rotor cores and the stator cores and, therefore, reduces the percent defectives, problems inherent in the prior art. Moreover, neither a stock warehouse nor preservation is required, and the cost of production is thereby lowered.

Further, the rotor cores 70 and the stator cores 80 produced at the press station 10 are successively conveyed in parallel to the rotor assembling station 3 and to the stator assembling station 4, and are successively assembled into rotors 7 and stators 8. Therefore, the rotors 7 and the stators 8 are combined together into finished products in a minimum time.

Further, the press station 10 need have only a capability meeting the production capabilities of only one type of rotor assembling station 3 and only one type of stator assembling station 4. Unlike the prior art, therefore, there is no need for a large, high-speed and expensive punch press apparatus, and the related cost can be greatly decreased. Instead, plural similarly constituted motor production lines can be provided for producing motors of different specifications. Therefore, many types of motors can be optimally produced in small quantities.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. (canceled)

2. (canceled)

3. (canceled)

4. (canceled)

5. (canceled)

6. (canceled)

7. A motor production line for producing at least a stator for a motor, comprising:
a press station for forming a stator core by feeding an elongated steel plate through a plurality of punch operations to obtain a plurality of steel plates and for laminating the plurality of steel plates together to form a stator core;
a stator assembling station for assembling a stator by passing the stator core through a plurality of production steps; and
a stator core conveyer between the stator assembling station and the press station to successively and directly convey the stator cores formed at the press station to the stator assembling station.

8. A motor production line according to claim 7, wherein said press station comprises a punch press for cutting the steel plates for both stator cores and rotor cores and apparatus for laminating pluralities of the cut steel plates into rotor cores and stator cores, and wherein the motor production line further comprises:
a rotor assembling station for assembling a rotor by passing the rotor core through a plurality of production steps; and
a rotor core conveyer arranged between the rotor assembling station and the press station to successively and directly convey the rotors formed at the press station to the rotor assembling station.

9. A motor production line according to claim 8, wherein the motor production line further comprises a central control unit for controlling apparatus in the press station, apparatus in the stator assembling station, apparatus in the rotor assembling station, the stator core conveyer and the rotor core conveyer.

10. A motor production line according to claim 8, wherein the rotor core conveyer and the stator core conveyer are linked together as a single common conveyer.

11. A motor production line according to claim 8, further comprising a rotor delivery line for delivering the rotors assembled at the rotor assembling station and a stator delivery line for delivering the stators assembled at the stator assembling station, to a common delivery line where rotors and stators are delivered and paired for incorporation into a motor.

12. A motor production line according to claim 11, wherein the motor production line further comprises a central control unit for controlling apparatus in the press station, apparatus in the stator assembling station, apparatus in the rotor assembling station, the stator core conveyer and the rotor core conveyer.

13. A motor production line according to claim 11, wherein the rotor core conveyer and the stator core conveyer are linked together as a single common constituted conveyer.

14. A method of controlling a motor production line including a press station for forming a rotor core and a stator core by feeding a long steel plate through a plurality of punch press operations to form pluralities of steel plates and by laminating the pluralities of steel plates into rotor cores and stator cores, respectively, a rotor assembling station for assembling a rotor by passing the rotor core through a plurality of production steps, and a stator assembling station for assembling a stator by passing the stator core through a plurality of production steps, the method of controlling the motor production line comprising:
accepting a production instruction inclusive of data related to a number N of motors to be produced;
starting the operations of apparatus at the press station, the rotor assembling station and the stator assembling station, responsive to acceptance of the production instruction; and
halting the operation of the apparatus at the press station depending upon the production conditions in the rotor assembling station and the stator assembling station; wherein
if the number of the finished rotors assembled at the rotor assembling station is denoted as R₁, the number of the half assembled rotors as R₂, the number of the finished stators assembled by the stator assembling station as S₁ and the number of the half assembled stators at S₂, then, said halting of operations at the press station is halted by a central controller when N≦R₁+R₂ and N≦S₁+S₂.
